(19) United States
(12) Patent Application Publication
(10) Pub. No.: US 2024/0276518 A1
(43) Pub. Date: Aug. 15, 2024

(54) BLIND DECODING FOR MULTIPLE DOWNLINK CONTROL INFORMATION

(71) Applicant: Apple Inc., Cupertino, CA (US)

(72) Inventors: Ankit BHAMRI, Bad Nauheim (DE); Wei ZENG, Saratoga, CA (US); Hong HE, San Jose, CA (US); Dawei ZHANG, Saratoga, CA (US)

(73) Assignee: Apple Inc., One Apple Park Way, CA (US)

(21) Appl. No.: 18/537,042

(22) Filed: Dec. 12, 2023

Related U.S. Application Data
(60) Provisional application No. 63/444,758, filed on Feb. 10, 2023.

(51) Int. Cl. H04W 72/232; H04L 1/00; H04W 72/12; H04W 72/51

(52) U.S. Cl. CPC H04W 72/232; H04L 1/0038; H04W 72/12; H04W 72/51

(57) ABSTRACT

Some aspects relate to a carrier aggregation wireless system having a user equipment (UE). The UE can generate a report of a UE capability to support a first downlink control information (DCI) in a first DCI format for a cell of a plurality of cells of the wireless system and a second DCI in a second DCI format for the cell, and a report of a UE capability to support splitting a blind decoding (BD) of control channel element (CCE) (BD/CCE) budget between performing BD/CCE carrying the first DCI in the first DCI format, and performing BD/CCE carrying the second DCI in the second DCI format. The first DCI in the first DCI format can schedule data transmissions for a set of multiple cells. The UE may perform BD/CCE carrying the first DCI in the first DCI format, and perform BD/CCE carrying the second DCI in the second DCI format.

### CROSS-REFERENCE TO RELATED APPLICATIONS

This application claims the benefit of U.S. Provisional Application No. 63/444,758, filed Feb. 10, 2023, the contents of which are incorporated herein by reference in its entirety.

### BACKGROUND

### Field

The described aspects generally relate to wireless communication, including supporting blind decoding (BD) control channel element (CCE) (BD/CCE) for multiple downlink control information (DCI) scheduling of a carrier aggregation (CA) wireless system.

### Related Art

A wireless communication system can include a fifth generation (5G) system, a New Radio (NR) system, a long term evolution (LTE) system, a non-terrestrial wireless network (NTN), a combination thereof, or some other wireless systems. In addition, a wireless communication system can support a wide range of use cases such as enhanced mobile broad band (eMBB), massive machine type communications (mMTC), ultra-reliable and low-latency communications (URLLC), enhanced vehicle to anything communications (eV2X), among others. A carrier aggregation (CA) wireless system may include multiple transmission reception points (TRPs) or base stations located in multiple cells of the wireless system in communication with a user equipment (UE). Downlink control information (DCI) may be used to schedule data transmissions. Efficiency may be desired in DCI scheduling.

### SUMMARY

Some aspects of this disclosure relate to apparatuses and methods for implementing a UE capability to support a first downlink control information (DCI) in a first DCI format for a cell of a plurality of cells of a carrier aggregation (CA) wireless system and a second DCI in a second DCI format for the cell. The first DCI in the first DCI format can schedule data transmissions for a set of multiple cells of the plurality of cells of the CA wireless system. The UE may perform blind decoding (BD) of control channel element (CCE) (BD/CCE) carrying the first DCI in the first DCI format, and perform BD/CCE carrying the second DCI in the second DCI format. UE can further split a BD/CCE budget between performing BD/CCE carrying the first DCI and performing BD/CCE carrying the second DCI.

Some aspects of this disclosure relate to a UE. The UE can include a transceiver, and a processor communicatively coupled to the transceiver. The transceiver can be configured to enable wireless communication in a CA wireless system having a plurality of cells. The processor of the UE can generate a report of a UE capability to support splitting a BD/CCE budget between performing BD/CCE carrying a first DCI in a first DCI format, and performing BD/CCE carrying a second DCI in a second DCI format. The first DCI format can indicate the first DCI is configured to schedule data transmissions for a set of multiple cells of the plurality of cells of the CA wireless system by the first DCI. In some embodiments, the second DCI format can include a cross carrier scheduling (CCS) DCI or a self-scheduling DCI. The processor can further transmit the report to a base station.

In some embodiments, the processor can further configure the UE to perform blind decoding of a first number of CCEs carrying the first DCI, and blind decoding of a second number of CCEs carrying the second DCI, where the first number of CCEs and the second number of CCEs are determined by the base station based on a splitting factor and the BD/CCE budget. In some embodiments, the splitting factor can be included in the UE capability reported by the UE and received by the base station. In some embodiments, the splitting factor can be determined by the base station without being included in the UE capability reported by the UE. A sum of the first number of CCEs and the second number of CCEs can be equal to the BD/CCE budget and less than or equal to a predetermined CCE limit.

In some embodiments, the processor can further monitor a first group of CCE candidates corresponding to the first DCI to perform blind decoding until the first number of CCEs carrying the first DCI have been blind decoded, and monitor a second group of CCE candidates corresponding to the second DCI to perform blind decoding until the second number of CCEs carrying the second DCI have been blind decoded. In some embodiments, the first group of CCE candidates can be allocated to search space set (SSS) indices {1, 2, 3} associated with the first DCI format, and the second group of CCE candidates can be allocated to SSS indices {4, 5, 6} associated with the second DCI format. In some embodiments, after the first number of CCEs carrying the first DCI have been blind decoded, the processor can further monitor only the second group of CCE candidates corresponding to the second DCI to perform blind decoding until the second number of CCEs carrying the second DCI have been blind decoded. Similarly, after the second number of CCEs carrying the second DCI have been blind decoded, the processor can further monitor only the first group of CCE candidates corresponding to the first DCI to perform blind decoding until the first number of CCEs carrying the first DCI have been blind decoded.

Some aspects of this disclosure relate to a method performed by a UE. The UE can transmit a report to indicate whether the UE has a capability to support a first DCI in a first DCI format for a cell of a plurality of cells of a CA wireless system and a second DCI in a second DCI format for the cell. The first DCI format can indicate the first DCI is configured to schedule data transmissions for a set of multiple cells of the wireless system, and the second DCI can include a cross carrier scheduling (CCS) DCI.

In some embodiments, the report can indicate the UE has the capability to support the first DCI and the second DCI for all the cells configured for the UE including the cell. In some embodiments, the cell is a first cell and the report is a first report, and the UE can further transmit a second report indicating whether the UE has the capability for a second cell of the plurality of cells of the CA wireless system.

In some embodiments, the UE can be configured to support the first DCI in the first DCI format and the second DCI in the second DCI format when the UE has the capability to support both the first DCI and the second DCI. The UE can further monitor a first group of CCE candidates corresponding to the first DCI to perform blind decoding of a first number of CCEs carrying the first DCI, and monitor a second group of CCE candidates corresponding to the second DCI to perform blind decoding of a second number of CCEs carrying the second DCI. A sum of the first number of CCEs and the second number of CCEs can be less than or equal to a predetermined CCE limit.

In some embodiments, the UE can be configured to support the first DCI and the second DCI by a single CCS information element (IE), where the CCS IE can include a parameter to indicate whether the first DCI in the first DCI format is supported for the cell. In some embodiments, the UE can be configured to support the first DCI in the first DCI format by a first IE, and configured to support the second DCI in the second DCI format by a second IE different from the first IE.

In some embodiments, the UE can transmit the report to indicate an additional capability of the UE to allow the cell being scheduled by the first DCI that is used to schedule only the cell without scheduling any additional cell at a same time. Accordingly, the UE can determine the first DCI received by decoding the first number of CCEs to be a valid DCI.

In some embodiments, the report can indicate the UE does not have the capability to support the first DCI and the second DCI. Accordingly, the UE can monitor the first group of CCE candidates corresponding to the first DCI to perform blind decoding of the first number of CCEs to receive the first DCI, where the first DCI is configured to schedule data transmissions for the cell alone.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates a wireless system to perform blind decoding of a first downlink control information (DCI) in a first DCI format and a second DCI in a second DCI format, according to some aspects of the disclosure.

FIG. 2 illustrates a block diagram of a UE to perform functions described herein, according to some aspects of the disclosure.

FIG. 3 illustrates an example process performed by a UE to perform blind decoding of a first DCI in a first DCI format and a second DCI in a second DCI format, according to some aspects of the disclosure.

FIG. 4 illustrates an example process performed by a UE to perform blind decoding of a first DCI in a first DCI format and a second DCI in a second DCI format, according to some aspects of the disclosure.

FIG. 5 is an example computer system for implementing some aspects or portion(s) thereof of the disclosure provided herein.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In a wireless system, a user equipment (UE) can transmit and receive data on one or multiple component carriers (CC) using coordinated multi-point transmission or carrier aggregation (CA). In traditional cellular networks, a UE may be connected only to a single transmission reception point (TRP) or a base station at a time and each base station makes independent scheduling, precoding, and resource allocation decisions. For a CA wireless system, multiple TRPs or base stations cooperate and coordinate their transmissions such that a UE can receive transmissions from multiple base stations simultaneously to increase the throughput of the UE. For example, a UE may communicate with a first base station (e.g., a primary cell (PCell), a first component carrier) and with a second base station (e.g., a secondary cell (SCell), a second component carrier) at the same time. Additionally or alternatively, a single base station may include multiple cells (e.g., both a PCell and a SCell, or multiple component carriers), where the UE communicates with two or more cells on the single base station at the same time. A wireless system can operate in various frequency ranges, such as frequency range 1 (FR1) within 410-7125 MHz range and frequency range 1 (FR2) within 24250-52600 MHz range.

In a wireless system, the physical downlink control channel (PDCCH) can carry downlink control information (DCI), which can contain scheduling information for the uplink (UL) or downlink (DL) data channels and other control information for a UE or a group of UEs. The UE can obtain control information by monitoring control channel elements (CCEs) of a set of physical resources, such as control resource set (CORESET) at a designated monitoring occasion. The UE can perform a blind detection or blind decoding in the candidate set in the configured search space to obtain the DCI. A PDCCH can have a basic unit as a CCE including a number of resource element groups (REGs). In some systems, a DCI may be used to schedule data transmissions for a UE in a single cell. A different kind of DCI, such as a multi-cell scheduling for physical downlink shared channel (PDSCH)/physical uplink shared channel (PUSCH), can use a single DCI to schedule data transmissions for a UE in multiple cells, which can be more efficient. However, how to support multiple DCI formats for a UE can be a challenge.

Embodiments herein present techniques to support at least two different DCIs in two different DCI formats to perform different scheduling for a UE. For example, a DCI format can indicate a DCI is configured to schedule data transmissions for a set of multiple cells of a plurality of cells of a CA wireless system. In addition, a DCI format can indicate a cross carrier scheduling (CCS) DCI, or a self-scheduling DCI. A UE can have a capability to support a first DCI in a first DCI format for a cell of a plurality of cells of a CA wireless system and a second DCI in a second DCI format for the cell, where the first DCI format indicates the first DCI is configured to schedule data transmissions for a set of multiple cells of the wireless system, and the second DCI includes a cross carrier scheduling (CCS) DCI. In addition, a UE can have a capability to support splitting a blind decoding (BD) CCE (BD/CCE) budget between performing BD/CCE carrying a first DCI in a first DCI format, and performing BD/CCE carrying a second DCI in a second DCI format, where the first DCI format indicates the first DCI is configured to schedule data transmissions for a set of multiple cells by the first DCI. In some embodiments, a DCI can be used for both intra-band and inter-band CA operation, and for both FR1 and FR2. In some embodiments, a single DCI can be used for 3 or more cells for the multi-cell PUSCH/PDSCH scheduling.

In some embodiments, a UE can obtain control information by monitoring CCEs of a set of physical resources at a designated monitoring occasion, and perform a blind detection or blind decoding in the candidate set in the configured search space. In some embodiments, the UE can perform blind decoding of a first number of CCEs carrying the first DCI, and blind decoding of a second number of CCEs carrying the second DCI, where the first number of CCEs and the second number of CCEs are determined by the base station based on a splitting factor and the BD/CCE budget. In some embodiments, the splitting factor can be included in the UE capability reported by the UE and received by the base station. In some embodiments, the splitting factor can be determined by the base station without being included in the UE capability reported by the UE. A sum of the first number of CCEs and the second number of CCEs can be equal to the BD/CCE budget and less than or equal to a predetermined CCE limit.

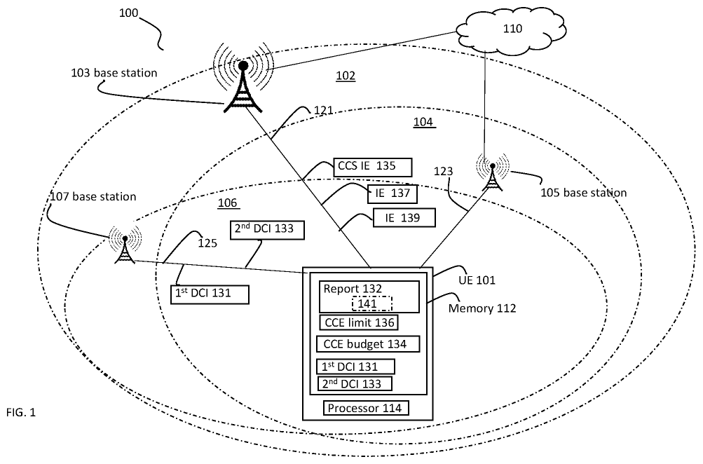

FIG. 1 illustrates a wireless system 100 to perform blind decoding of a first DCI in a first DCI format and a second DCI in a second DCI format, according to some aspects of the disclosure. Wireless system 100 is provided for the purpose of illustration only and does not limit the disclosed aspects. Wireless system 100 can include, but is not limited to, UE 101, a base station 103, a base station 105, and a base station 107, all communicatively coupled to a core network 110. UE 101 communicates with base station 103 over a communication link 121, communicates with base station 105 over a communication link 123, and communicates with base station 107 over a communication link 125. A base station may be a TRP. For example, base station 105, or base station 107 can be a TRP.

In some examples, wireless system 100 can include one or more of a NR system, a LTE system, a 5G system, or some other wireless system. There can be other network entities, e.g., network controller, a relay station, not shown. Wireless system 100 can support a wide range of use cases such as enhanced mobile broad band (eMBB), massive machine type communications (mMTC), ultra-reliable and low-latency communications (URLLC), and enhanced vehicle to anything communications (eV2X). System 100 can be a CA wireless system.

According to some aspects, base station 103, base station 105, and base station 107 can be a fixed station or a mobile station. Base station 103, base station 105, and base station 107 can also be called other names, such as a base transceiver system (BTS), an access point (AP), a TRP, an evolved NodeB (eNB), a next generation node B (gNB), a 5G node B (NB), or some other equivalent terminology. In some examples, base station 103 can be a gNB, while base station 105 and base station 107 can be a gNB, an eNB, or TRP. In some examples, base station 103, base station 105, and base station 107 can be interconnected to one another and/or to other base station or network nodes in a network through various types of backhaul interfaces such as a direct physical connection, a virtual network, and/or the like, not shown.

According to some aspects, UE 101 can be stationary or mobile. UE 101 can be a cellular phone (e.g., a smart phone), a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to communicate via a wireless medium. For example, a MTC and eMTC device can include, a robot, a drone, a location tag, and/or the like.

According to some aspects, base station 103, base station 105, and base station 107 can be communicatively coupled to core network 110. Base station 103 can serve a cell 102, base station 105 can serve a cell 104 contained within cell 102, and base station 107 can serve a cell 106 contained within cell 102 that overlaps with cell 104. In some other embodiments, cell 102 can overlap partially with cell 104 or cell 106. Cell 102, cell 104, and cell 106 can be a macro cell, a pico cell, a femto cell, and/or another type of cell. In comparison, a macro cell can cover a relatively large geographic area, e.g., several kilometers in radius, a femto cell can cover a relatively small geographic area, e.g., a home, while a pico cell covers an area smaller than the area covered by a macro cell but larger than the area covered by a femto cell. For example, cell 102 can be a macro cell, while cell 104 and cell 106 can be a pico cell or a femto cell. In addition, cell 102 can be a pico cell while cell 104 and cell 106 can be a femto cell. In some examples, the geographic area of a cell can move according to the location of a mobile base station.

According to some aspects, base station 103 can be the serving base station, a primary node (PN), and cell 102 can be the serving cell or primary cell (PCell). Base station 105 and base station 107 can be neighbor base station to UE 101 that can be a secondary node (SN). Cell 104 and cell 106 can be a secondary cell (SCell), or a primary secondary cell (PScell). There can be other secondary cells for UE 101, not shown. Data for UE 101 can be simultaneously transferred between UE 101 and core network 110 by one or more component carriers between UE 101 and base station 103 at communication link 121, one or more component carriers between UE 101 and base station 105 at communication link 123, and one or more component carriers between UE 101 and base station 107 at communication link 125. UE 101 can communicate with the serving base station, e.g., base station 103, using a first frequency band, and communicate with a neighbor base station, e.g., base station 105 or base station 107 using a second frequency band different from the first frequency band. In some embodiments, cell 102, which is the PCell, may be referred to as the anchor cell that provides a radio resource control (RRC) connection to the UE 101. In some examples, the PCell (cell 102) and the SCell, e.g., cell 104, may be co-located (e.g., different TRPs at the same location).

In some embodiments, one or more of the SCells, such as cell 104 or cell 106, may be activated or added to cell 102, which is the PCell, to form the serving cells serving the UE 101. Each serving cell corresponds to one or more CCs. The CC of the PCell, e.g., cell 102, may be referred to as a primary CC (PCC), and the CC of a SCell, e.g., cell 104 or cell 106, may be referred to as a secondary CC (SCC). The PCell (cell 102) and one or more of the SCells (cell 104 or cell 106) may be served by a respective base station 103, 105, and 107. The coverages of the PCell and SCell may differ since component carriers in different frequency bands may experience different path loss. In some embodiments, the PCell (cell 102) may add or remove one or more of the SCells (cell 104 or cell 106) to improve reliability of the connection to the UE 101 and/or increase the data rate.

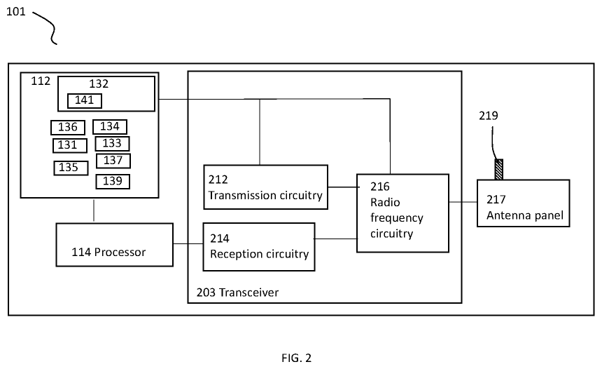

According to some aspects, UE 101 can include a memory 112, and a processor 114 communicatively coupled to the memory, and a transceiver, as shown in FIG. 2. Memory 112 can be configured to store various data and operations described below.

In some embodiments, processor 114 can generate a report 132 of a UE capability. In some embodiments, the UE capability can indicate UE 101 can support splitting a BD/CCE budget 134 between performing BD/CCE carrying a first DCI 131 in a first DCI format, and performing BD/CCE carrying a second DCI 133 in a second DCI format. The first DCI format can indicate the first DCI 131 is configured to schedule data transmissions for a set of multiple cells of the plurality of cells of the CA wireless system by the first DCI 131. For example, the first DCI 131 can schedule data transmissions for cell 104 and cell 106. In some embodiments, the second DCI format can include a cross carrier scheduling (CCS) DCI or a self-scheduling DCI. For example, the second DCI 133 can include a CCS DCI to schedule a cross carrier at cell 104, or schedule itself at cell 106. Processor 114 can further transmit report 132 to a base station, e.g., base station 103, or base station 107.

In some embodiments, processor 114 can further configure UE 101 to perform blind decoding of a first number of CCEs carrying the first DCI 131, and blind decoding of a second number of CCEs carrying the second DCI 133, where the first number of CCEs and the second number of CCEs are determined by base station 103 based on a splitting factor, e.g., a splitting factor 141 included in report 132, and BD/CCE budget 134. In some embodiments, splitting factor 141 is included in the UE capability reported by UE 101 and received by base station 103. In some embodiments, splitting factor 141 can be determined by the base station without being included in the UE capability reported by UE 101. In some embodiments, a sum of the first number of CCEs and the second number of CCEs can be equal to the BD/CCE budget 134 and less than or equal to a predetermined CCE limit 136.

In some embodiments, processor 114 can further monitor a first group of CCE candidates corresponding to the first DCI 131 to perform blind decoding until the first number of CCEs carrying the first DCI 131 have been blind decoded. By performing blind decoding, processor 114 may not have the accurate information as where the DCI 131 may be located within the search space where the first group of CCE candidates are located, and may not have the information about the structure of the DCI such as the aggregation level, and may not have the scrambling code such as radio network temporary identifier (RNTI). Processor 114 may have to determine the exact value for location (CCE index), structure, and scrambling code (RNTI) by trial and error, hence referred to as the blind decoding. Processor 114 can also monitor a second group of CCE candidates corresponding to the second DCI 133 to perform blind decoding until the second number of CCEs carrying the second DCI 133 have been blind decoded. In some embodiments, the first group of CCE candidates can be allocated to search space set (SSS) indices {1, 2, 3} associated with the first DCI format, and the second group of CCE candidates can be allocated to SSS indices {4, 5, 6} associated with the second DCI format. In some embodiments, after the first number of CCEs carrying the first DCI 131 have been blind decoded, processor 114 can further monitor only the second group of CCE candidates corresponding to the second DCI 133 to perform blind decoding until the second number of CCEs carrying the second DCI 133 have been blind decoded. Similarly, after the second number of CCEs carrying the second DCI 133 have been blind decoded, processor 114 can further monitor only the first group of CCE candidates corresponding to the first DCI 131 to perform blind decoding until the first number of CCEs carrying the first DCI 131 have been blind decoded.

In some embodiments, UE 101 can transmit report 132 to indicate whether UE 101 has a capability to support the first DCI 131 in a first DCI format for a cell, such as cell 106, and a second DCI 133 in a second DCI format for the cell, e.g., cell 106. The first DCI format can indicate the first DCI 131 is configured to schedule data transmissions for a set of multiple cells of the wireless system, such as cell 106, cell 104, and cell 102, and the second DCI 131 can include a cross carrier scheduling (CCS) DCI, which can schedule only one cell, such as cell 104 having a cross carrier that is a carrier in cell 104 different from cell 106.

In some embodiments, report 132 can indicate UE 101 has the capability to support the first DCI 131 and the second DCI 133 for all the cells configured for UE 101, such as cell 106, cell 104, and cell 102. In some embodiments, cell 106 is a first cell and report 132 is a first report, and UE 101 can further transmit a second report indicating whether UE 101 has the capability for a second cell, such as cell 104.

In some embodiments, UE 101 can be configured to support the first DCI 131 in the first DCI format and the second DCI 133 in the second DCI format when UE 101 has the capability to support both the first DCI 131 and the second DCI 133. UE 101 can further monitor a first group of CCE candidates corresponding to the first DCI 131 to perform blind decoding of a first number of CCEs carrying the first DCI 131, and monitor a second group of CCE candidates corresponding to the second DCI 133 to perform blind decoding of a second number of CCEs carrying the second DCI 133. A sum of the first number of CCEs and the second number of CCEs can be less than or equal to the predetermined CCE limit 136. In some embodiments, the predetermined CCE limit 136 may be defined by the system design, and may be bigger than the first number of CCEs and the second number of CCEs.

In some embodiments, UE 101 can be configured to support the first DCI 131 and the second DCI 133 by a single CCS information element (IE) 135 received from base station 103, where the CCS IE can include a parameter to indicate whether the first DCI 131 in the first DCI format is supported for the cell. In some embodiments, UE 101 can be configured to support the first DCI 131 in the first DCI format by a first IE 137 received from base station 103, and configured to support the second DCI 133 in the second DCI format by a second IE 139 different from the first IE 137.

In some embodiments, UE 101 can transmit report 132 to indicate an additional capability of UE 101 to allow cell 106 being scheduled by the first DCI 131 that is used to schedule only cell 106 without scheduling any additional cell at a same time. Accordingly, UE 101 can determine the first DCI 131 received by decoding the first number of CCEs to be a valid DCI.

In some embodiments, report 132 can indicate UE 101 does not have the capability to support the first DCI 131 and the second DCI 133. Accordingly, UE 101 can monitor the first group of CCE candidates corresponding to the first DCI 131 to perform blind decoding of the first number of CCEs to receive the first DCI 131, where the first DCI 131 is configured to schedule data transmissions for the cell alone.

FIG. 2 illustrates a block diagram of UE 101, having antenna panel 217 including one or more antenna elements, e.g., an antenna element 219 coupled to transceiver 203 and controlled by processor 114. In detail, transceiver 203 can include radio frequency (RF) circuitry 216, baseband transmission circuitry 212, and baseband reception circuitry 214. RF circuitry 216 can include multiple parallel RF chains for one or more of transmit or receive functions, each connected to one or more antenna elements of the antenna panel. Transceiver 203, via antenna panel 217, enables wireless communication for UE 101 with base station 103, base station 105, and base station 107. In addition, processor 114 can be communicatively coupled to memory 112, which is further coupled to transceiver 203.

In some examples, RF circuitry 216 is used by UE 101 to perform measurements of reference signals, and to transmit and receive data in the serving cell. Memory 112 can store the first DCI 131 and the second DCI 133, report 132, CCS IE 135, the first IE 137, the second IE 139, the predetermined CCE limit 136, splitting factor 141, and BD/CCE budget 134, as described in FIG. 1.

In some examples, memory 112 can include instructions, that when executed by processor 114 perform the functions described herein, including performing blind decoding of a first DCI in a first DCI format and a second DCI in a second DCI format. Alternatively, processor 114 can be “hard-coded” to perform the functions described herein, including performing blind decoding of a first DCI in a first DCI format and a second DCI in a second DCI format described herein.

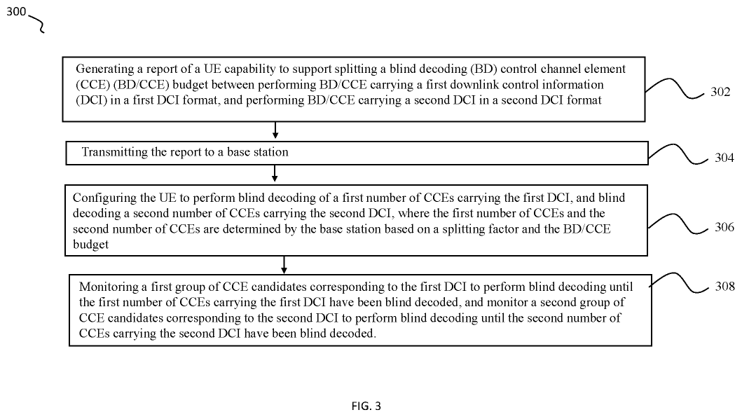

FIG. 3 illustrates an example process 300 performed by a UE to perform blind decoding of a first DCI in a first DCI format and a second DCI in a second DCI format, according to some aspects of the disclosure. Process 300 can be performed by UE 101 as shown in FIGS. 1-2.

At 302, UE 101 can generate report 132 of a UE capability to support splitting BD/CCE budget 134 between performing BD/CCE carrying a first DCI 131 in a first DCI format, and performing BD/CCE carrying a second DCI 133 in a second DCI format. The first DCI format indicates the first DCI 131 is configured to schedule data transmissions for a set of multiple cells by the first DCI 131. In some embodiments, the first DCI format may be a DCI format 0_X/1_X, which can be a new DCI format used to schedule multi-cell data transmission and denoted as mcDCI. The first DCI format, mcDCI, can be different from the legacy DCI formats, such as DCI format 0_0, format 0_1, format 1_0, format 1_1, format 2_0, format 2_1, format 2_2, format 2_3, format 2_4, format 2_5, format 2_6, format 3_0, format 3_1. The second DCI format can be a legacy DCI format.

At 304, UE 101 can transmit report 132 to base station 103, or base station 107.

At 306, UE 101 can be configured to perform blind decoding of a first number of CCEs carrying the first DCI 131, and blind decoding of a second number of CCEs carrying the second DCI 133. The first number of CCEs and the second number of CCEs can be determined by base station 103, or other base stations such as base station 107, based on splitting factor 141 and BD/CCE budget 134.

In some embodiments, UE 101 can report splitting factors that UE 101 can support. If UE 101 does not report the capability of supporting splitting factors, base station 103 can configure any combination of PDCCH/CCE candidates for mcDCI and legacy DCI formats. In some embodiments, a total sum of the PDCCH/CCE candidates for both mcDCI and legacy DCI formats may remain within the limit BD/CCE limits per cell, such as within the predetermined CCE limit 136. If a splitting factor is reported, base station 103 can still overbook for PDCCH budget while taking into consideration of the splitting factor as well as the total PDCCH budget.

In some embodiments, UE 101 can be configured to associate the first DCI format, such as mcDCI, with search spaces such as SSS index 1, SSS index 2, SSS index 3, and also configured to associate the second DCI format, such as a legacy DCI format, with search spaces with SSS index 4, SSS index 5 and SSS index 6.

At 308, UE 101 can monitor a first group of CCE candidates corresponding to the first DCI 131 to perform blind decoding until the first number of CCEs carrying the first DCI 131 have been blind decoded, and monitor a second group of CCE candidates corresponding to the second DCI 133 to perform blind decoding until the second number of CCEs carrying the second DCI 133 have been blind decoded.

In some embodiments, splitting factor 141 can be reported as 0.75 by UE 101. Accordingly, 75% of the total PDCCH/CCE budget limit 134 can be allocated for SSS indices {1,2,3} associated with mcDCI and remaining 25% of the total PDCCH/CCE budget limit 134 can be allocated for SSS indices {4, 5, 6} associated with legacy DCI formats. When the allocated budget limit is reached for mcDCI while monitoring for SSS indices 1 and 3, UE 101 can skip monitoring PDCCH/CCE candidates corresponding to SSB index 1, 2 or 3 since it is associated with mcDCI and the allocated budget is used. However, UE 101 can continue monitoring PDCCH/CCE candidates associated with SSB index 4, 5, or 6 since that budget separately corresponds to legacy DCI formats. Once the allocated budget for legacy DCI formats is reached, UE 101 is not required to monitor the remaining PDCCH candidates, as legacy behavior.

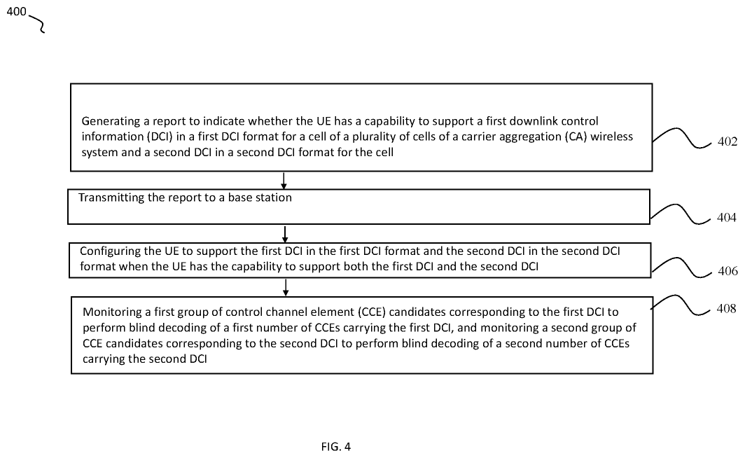

FIG. 4 illustrates an example process 400 performed by a UE to perform blind decoding of a first DCI in a first DCI format and a second DCI in a second DCI format, according to some aspects of the disclosure. Process 400 can be performed by UE 101 as shown in FIGS. 1-2.

At 402, UE 101 can generate a report to indicate whether the UE has a capability to support the first DCI 131 in a first DCI format for cell 106 and the second DCI 133 in a second DCI format for cell 106. The first DCI format indicates the first DCI 131 can be configured to schedule data transmissions for a set of multiple cells, such as a mcDCI format, and the second DCI 133 can include a CCS DCI. At 404, UE can transmit the report to a base station.

If UE 101 reports a capability to support both single DCI based multi-cell scheduling, such as mcDCI, as well as cross-carrier scheduling for cell 106, UE 101 may further report additional limitation or capability, whether cell 106 can be scheduled by single DCI based multi-cell scheduling alone or not. In some embodiments, a single multi-cell scheduling DCI cannot schedule the given cell alone, instead, the single multi-cell scheduling DCI, mcDCI, should schedule multiple cells including cell 106 along with at least one other cell, such as cell 104. In some embodiments, there can be a set of multiple cells (up to 4) that can be scheduled by single scheduling cell, cell 106, using a single DCI format that is mcDCI. In case UE capability includes such an additional limitation, if a mcDCI schedules only one cell having a component carrier, such a mcDCI schedule would be invalid. Accordingly, the first DCI 131 of mcDCI format indicating scheduling only one cell would be invalid. Instead, the component carrier of the cell can be scheduled by legacy DCI format. In some embodiments, the first DCI 131 of mcDCI format can be used to schedule two different component carriers in two different cells. Accordingly, the first DCI 131 is a valid DCI according to the additional capability of UE 101 as reported. Accordingly, the BD/CCE operations can be counted towards the budget or limit towards the scheduled cell with CCS, since mcDCI contains scheduling information for such multiple cells. Without the additional limitation to schedule multiple cells, the BD/CCE may always be counted towards the one cell that is configured by base station 103 on which BD/CCE counting for mcDCI is done, causing the BD/CCE budgets on one cell be quickly exhausted.

In some embodiments, the UE capability supporting the first DCI 131 in a first DCI format for cell 106 and the second DCI 133 in a second DCI format for the cell 106 can be reported either on per-cell basis or per-UE basis. If the UE capability is reported on per-cell basis, separate UE capability may be reported for each of the cells. If the UE capability is reported on per-UE basis, same capability can be applied to all the configured cells, such as cell 106, cell 104, and cell 102.

In some embodiments, if UE 101 reports capability to not support both single DCI based multi-cell scheduling for a cell and CCS, cell 106 can be scheduled by single DCI based multi-cell scheduling only as one cell. Hence, mcDCI schedules can schedule the given cell alone.

At 406, UE 101 can be configured to support the first DCI in the first DCI format and the second DCI in the second DCI format when the UE has the capability to support both the first DCI and the second DCI.

In some embodiments, RRC configuration for multi-cell scheduling of UE 101 can include various options. In some embodiments, when CCS and multi-cell scheduling can be supported for a cell, UE 101 can be configured with both multi-cell scheduling and CCS configuration for a cell using the same IE. In one example, the CCS IE can be enhanced to include a parameter to indicate if multi-cell scheduling is supported for this cell. An illustration of the configuration is shown where, Mcif-InSchedulingCell corresponding to a set of cells is proposed. The presence of this parameter can indicate to UE 101 that multi-cell scheduling is configured for this cell and also the associated cell group based on value of mCIF. In another option, new IE for multi-cell scheduling configuration (similar to CCS IE, but with mCIF) can be configured to UE.

-- ASN1START
-- TAG-CROSSCARRIERSCHEDULINGCONFIG-START

| | |
|---|---|
| CrossCarrierSchedulingConfig ::- | SEQUENCE { |
| schedulingCellInfo | CHOICE { |
| own | SEQUENCE { -- Cross carrier |

scheduling: scheduling cell

| | |
|---|---|
| cif-Presence | BOOLEAN |

},

| | |
|---|---|
| other | SEQUENCE { -- Cross carrier |

scheduling: scheduling cell

| | |
|---|---|
| schedulingCellId | ServCellIndex, |
| cif-InSchedulingCell | INTEGER (1..7) |
| Mcif-InSchedulingCell | INTEGER (1..7) |

```
    }
  },
  ...,
  [[
```

| | |
|---|---|
| carrierIndicatorSize-r16 | SEQUENCE { |
| carrierIndicatorSizeDCI-1-2-r16 | INTEGER (0..3), |
| carrierIndicatorSizeDCI-0-2-r16 | INTEGER (0..3) |

}
OPTIONAL, -- Cond CIF-PRESENCE

| | |
|---|---|
| enableDefaultBeamForCCS-r16 | ENUMERATED {enabled} |

```
OPTIONAL -- Need S
  ]],
  [[
```

| | |
|---|---|
| ccs-BlindDetectionSplit-r17 | ENUMERATED {oneSeventh, threeFourteenth, twoSeventh, |

threeSeventh,

oneHalf, fourSeventh, fiveSeventh, spare1}

OPTIONAL -- Need R
]]|
}
-- TAG-CROSSCARRIERSCHEDULINGCONFIG-STOP
-- ASN1STOP

At 408, UE 101 can monitor a first group of control channel element (CCE) candidates corresponding to the first DCI to perform blind decoding of a first number of CCEs carrying the first DCI, and monitoring a second group of CCE candidates corresponding to the second DCI to perform blind decoding of a second number of CCEs carrying the second DCI.

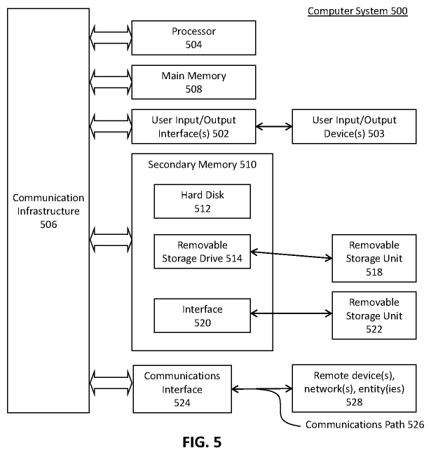

Various aspects can be implemented, for example, using one or more computer systems, such as computer system 500 shown in FIG. 5. Computer system 500 can be any computer capable of performing the functions described herein such as UE 101, base station 103, base station 105, or base station 107, in FIGS. 1-2, for operations described for process 300 or process 400 as shown in FIGS. 3-4. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 508, the removable storage unit 518, the removable storage unit 522 can store instructions that, when executed by processor 504, cause processor 504 to perform operations for a UE or a base station, e.g., UE 101, base station 103, base station 105, or base station 107, in FIGS. 1-2, for operations described for process 300 or process 400 as shown in FIGS. 3-4.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526. Operations of the communication interface 524 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communication in a carrier aggregation (CA) wireless system having a plurality of cells; and
a processor communicatively coupled to the transceiver and configured to:
generate a report of a UE capability to support splitting a blind decoding (BD) control channel element (CCE) (BD/CCE) budget between performing BD/CCE carrying a first downlink control information (DCI) in a first DCI format, and performing BD/CCE carrying a second DCI in a second DCI format, wherein the first DCI format indicates the first DCI is configured to schedule data transmissions for a set of multiple cells of the plurality of cells of the CA wireless system by the first DCI;
transmit the report to a base station;
configure the UE to perform blind decoding of a first number of CCEs carrying the first DCI, and blind decoding a second number of CCEs carrying the second DCI, wherein the first number of CCEs and the second number of CCEs are determined by the base station based on a splitting factor and the BD/CCE budget;
monitor a first group of CCE candidates corresponding to the first DCI to perform blind decoding until the first number of CCEs carrying the first DCI have been blind decoded, and monitor a second group of CCE candidates corresponding to the second DCI to perform blind decoding until the second number of CCEs carrying the second DCI have been blind decoded.

2. The UE of claim 1, wherein the splitting factor is included in the UE capability reported by the UE and received by the base station.

3. The UE of claim 1, wherein the splitting factor is determined by the base station without being included in the UE capability reported by the UE.

4. The UE of claim 1, wherein a sum of the first number of CCEs and the second number of CCEs is equal to the BD/CCE budget and less than or equal to a predetermined CCE limit.

5. The UE of claim 1, wherein the first group of CCE candidates are allocated to Search Space Set (SSS) indices {1, 2, 3} associated with the first DCI format, and the second group of CCE candidates are allocated to SSS indices {4, 5, 6} associated with the second DCI format.

6. The UE of claim 1, wherein the second DCI format includes a cross carrier scheduling (CCS) DCI or a self-scheduling DCI.

7. The UE of claim 1, wherein the processor is further configured to:
after the first number of CCEs carrying the first DCI have been blind decoded, monitor only the second group of CCE candidates corresponding to the second DCI to perform blind decoding until the second number of CCEs carrying the second DCI have been blind decoded; and
after the second number of CCEs carrying the second DCI have been blind decoded, monitor only the first group of CCE candidates corresponding to the first DCI to perform blind decoding until the first number of CCEs carrying the first DCI have been blind decoded.

8. A method for a user equipment (UE), comprising:
generating a report to indicate whether the UE has a capability to support a first downlink control information (DCI) in a first DCI format for a cell of a plurality of cells of a carrier aggregation (CA) wireless system and a second DCI in a second DCI format for the cell, wherein the first DCI format indicates the first DCI is configured to schedule data transmissions for a set of multiple cells of the wireless system, and the second DCI includes a cross carrier scheduling (CCS) DCI for a single cell;
transmitting the report to a base station;
configuring the UE to support the first DCI in the first DCI format and the second DCI in the second DCI format when the UE has the capability to support both the first DCI and the second DCI; and
monitoring a first group of control channel element (CCE) candidates corresponding to the first DCI to perform blind decoding of a first number of CCEs carrying the first DCI, and monitoring a second group of CCE candidates corresponding to the second DCI to perform blind decoding of a second number of CCEs carrying the second DCI.

9. The method of claim 8, further comprising:
transmitting the report to indicate an additional capability of the UE to allow the cell being scheduled by the first DCI that is used to schedule only the cell without scheduling any additional cell at a same time; and
determining the first DCI received by decoding the first number of CCEs to be a valid DCI.

10. The method of claim 8, wherein the report indicates the UE has the capability to support the first DCI and the second DCI for all the cells configured for the UE including the cell.

11. The method of claim 8, wherein the cell is a first cell and the report is a first report, and the transmitting the report further includes:
transmitting a second report indicating whether the UE has the capability for a second cell of the plurality of cells of the CA wireless system.

12. The method of claim 8, wherein the report indicates the UE does not have the capability to support the first DCI and the second DCI, and the method further includes:
monitoring the first group of CCE candidates corresponding to the first DCI to perform blind decoding of the first number of CCEs to receive the first DCI, wherein the first DCI is configured to schedule data transmissions for the cell alone.

13. The method of claim 8, wherein the configuring the UE to support the first DCI and the second DCI comprises:
configuring the UE to support the first DCI and the second DCI based on a single CCS information element (IE), wherein the single CCS IE includes a parameter to indicate whether the first DCI in the first DCI format is supported for the cell.

14. The method of claim 8, wherein the configuring the UE to support the first DCI and the second DCI comprises:
configuring the UE to support the first DCI in the first DCI format based on a first information element (IE); and
configuring the UE to support the second DCI in the second DCI format based on a second IE different from the first IE.

15. The method of claim 8, wherein a sum of the first number of CCEs and the second number of CCEs is less than or equal to a predetermined CCE limit.

16. A non-transitory computer-readable medium storing instructions that,
when executed by a processor of a user equipment (UE), cause the UE to perform operations, the operations comprising:
transmitting a report to indicate whether the UE has a capability to support a first downlink control information (DCI) in a first DCI format for a cell of a plurality of cells of a carrier aggregation (CA) wireless system and a second DCI in a second DCI format for the cell, wherein the first DCI format indicates the first DCI is configured to schedule data transmissions for a set of multiple cells of the wireless system, and the second DCI includes a cross carrier scheduling (CCS) DCI;
configuring the UE to support the first DCI in the first DCI format and the second DCI in the second DCI format when the UE has the capability to support both the first DCI and the second DCI; and
monitoring a first group of control channel element (CCE) candidates corresponding to the first DCI to perform blind decoding of a first number of CCEs carrying the first DCI, and monitoring a second group of CCE candidates corresponding to the second DCI to perform blind decoding of a second number of CCEs carrying the second DCI.

17. The non-transitory computer-readable medium of claim 16, wherein a sum of the first number of CCEs and the second number of CCEs is equal to the BD/CCE budget and less than or equal to a predetermined CCE limit.

18. The non-transitory computer-readable medium of claim 16, wherein the report indicates the UE has the capability to support the first DCI and the second DCI for all the cells configured for the UE including the cell.

19. The non-transitory computer-readable medium of claim 16, wherein the cell is a first cell and the report is a first report, and the transmitting the report further includes:
transmitting a second report indicating whether the UE has the capability for a second cell of the plurality of cells of the CA wireless system.

20. The non-transitory computer-readable medium of claim 16, wherein the report indicates the UE does not have the capability to support the first DCI and the second DCI, and the method further includes:
monitoring the first group of CCE candidates corresponding to the first DCI to perform blind decoding of the first number of CCEs to receive the first DCI, wherein the first DCI is configured to schedule data transmissions for the cell alone.
